(19) United States
(12) Patent Application Publication
(10) Pub. No.: US 2011/0243210 A1
(43) Pub. Date: Oct. 6, 2011

(54) APPARATUS AND METHOD FOR POWER SAVING USING REQUANTIZATION IN BASEBAND MODEM

(75) Inventors: Seo-Goo Lee, Gyeonggi-do (KR); Min-Cheol Park, Gyeonggi-do (KR); Byung-Tae Kang, Seoul (KR); Jin-Woo Roh, Gyeonggi-do (KR)

(73) Assignee: SAMSUNG ELECTRONICS CO., LTD., Suwon-city, Gyeonggi-do (KR)

(21) Appl. No.: 13/131,710

(22) PCT Filed: Nov. 27, 2009
(86) PCT No.: PCT/KR2009/007031

§ 371 Date: Jun. 21, 2011

(30) Foreign Application Priority Data
Nov. 28, 2008 (KR) 10-2008-0119336

(51) Int. Cl. H04W 52/02

(52) U.S. Cl. 375/227

(57) ABSTRACT

In the power saving, a method for saving power at a receiver of a mobile communication system includes acquiring Carrier to Interference plus Noise Ratio (CINR) and Modulation and Coding Scheme (MCS) information required by the receiver; determining the number of Least Significant Bits (LSBs) to hold based on the CINR and MCS information; and holding LSBs of the determined number of the bits in received information.

### TECHNICAL FIELD

The present invention relates to an apparatus and a method for minimizing power consumption of a baseband modem implemented using a digital circuit.

### BACKGROUND ART

Various schemes for reducing power consumption of a digital circuit are suggested in the related art.

FIG. 1 is a diagram of the schemes for lowering the power consumption in each step of a baseband modem design.

Referring to FIG. 1, when system requirements are set, a high level design is performed for an algorithm to satisfy the system requirements, implemented using a Hardware Description Language (HDL), and then finally implemented on a silicon (chip) through synthesis, replacement and routing.

In the circuit level design, a voltage scaling technique and a frequency scaling technique are adopted to lower the dynamic power consumption by changing the voltage applied to the circuit or the operating frequency of the clock. Also, a low voltage Vth cell technique for reducing the power consumption using a transistor of a low threshold voltage is adopted. A power gating technique is used to thoroughly block the voltage Vdd applied to the corresponding block while a particular block is not in use to lower the leakage power consumption.

The HDL level design utilizes techniques such as clock gating or operand isolation. The clock gating lowers the power consumption by blocking the toggling of the clock input to the corresponding sequential logic while the value of the sequential logic does not change. The operand isolation lowers the power consumption by blocking the toggling of the combinational logic circuit not stored. Both techniques are used to save the power.

As stated above, the demands for lowering the power consumption are gradually increasing. However, many low power design techniques in the HDL level design or the circuit level design are under process, whereas researches on solutions for lowering the power consumption in the high level design are relatively lacking.

Thus, an apparatus and a method for lowering the power consumption in the high level design are required.

### DISCLOSURE OF INVENTION

### Solution to Problem

An aspect of the present invention is to address at least the above mentioned problems and/or disadvantages and to provide at least the advantages described below. Accordingly, an aspect of the present invention is to provide an apparatus and a method for saving power using requantization in a baseband modem.

Another aspect of the present invention is to provide an apparatus and a method for lowering power consumption in a high level design for a baseband wireless communication modem constructed as a digital circuit.

According to one aspect of the present invention, a method for saving power at a receiver of a mobile communication system includes acquiring CINR and MCS information required by the receiver; determining the number of LSBs to hold based on the CINR and MCS information; and holding LSBs of the determined number of the bits in received information.

According to another aspect of the present invention, an apparatus of a receiver which saves power in a mobile communication system includes a quantization level controller for acquiring CINR and MCS information required by the receiver and determining the number of LSBs to hold based on the CINR and MCS information; and a reception part for holding LSBs of the determined number of the bits in received information.

According to yet another aspect of the present invention, a communication system for saving power in a mobile communication system includes a transmitter for transmitting information; and a receiver for acquiring CINR and MCS information required by the receiver, determining the number of LSBs to hold based on the CINR and MCS information, and holding LSBs of the determined number of the bits in received information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

The above and other aspects, features and advantages of certain exemplary embodiments the present invention will become more apparent from the following detailed description taken in conjunction with the accompanying drawings, in which:

FIG. 1 is a diagram of techniques for lowering power consumption in respective steps of a baseband modem design;

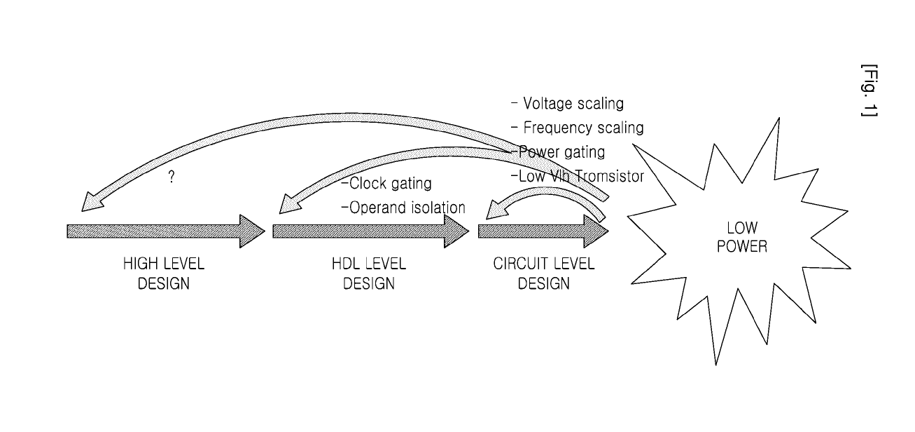

FIG. 2 is a diagram of performance of modulation schemes based on SNR in a wireless communication modem according to an exemplary embodiment of the present invention;

FIG. 3 is a block diagram of an apparatus according to an exemplary embodiment of the present invention;

FIG. 4 is a diagram of PER when performance saturation is applied according to an exemplary embodiment of the present invention;

FIG. 5 is a conceptual diagram of variation of quantization noise when LSB of a digital signal is held to zero in a terminal according to an exemplary embodiment of the present invention;

FIG. 6 is a diagram of a case where the technique of the present invention is applied to a simple 4-bit adder according to an exemplary embodiment of the present invention;

FIG. 7 is a diagram of dynamic power consumption when LSB 2 bits and 4 bits of the input bits of the LPF are held to zero according to an exemplary embodiment of the present invention;

FIG. 8 is a diagram of PER performance according to the bit holding according to an exemplary embodiment of the present invention;

FIG. 9 is a diagram of broadcast message reception at the terminal according to an exemplary embodiment of the present invention; and

FIG. 10 is a flowchart of a method for saving power by holding the LSB to zero at the terminal according to an exemplary embodiment of the present invention.

Throughout the drawings, like reference numerals will be understood to refer to like parts, components and structures.

### BEST MODE FOR CARRYING OUT THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide an apparatus and a method for saving power using requantization in a baseband modem.

According to the development of technologies, complexity of wireless communication equipment is considerably increasing. Hence, the power consumption of a mobile communication terminal (hereafter, referred to as a terminal) becomes a very important element. The power consumption of the baseband modem taking charge of radio communication occupies a great portion of the power consumption of the terminal.

The present invention provides a technique for minimizing the power consumption of the baseband modem implemented using a digital circuit. The power consumption in the digital circuit is divided to leakage power consumption and dynamic power consumption.

The leakage power consumption is the power basically spent regardless of the operation of the circuit, and the dynamic power consumption is the power consumed by the toggling of the transistor; that is, by the charging of the capacitor while the circuit is actually operating.

The low power design technique of the present invention decreases the toggling of the signal and thus lowers the dynamic power consumption by regulating the quantization noise of blocks positioned in the decoding chain in accordance with the decoding performance of the terminal required in the communication system.

That is, the present invention regulates the decoding performance of a receiver to lower the power consumption. One of the most important concerns in the high level design of the baseband wireless modem, which satisfies the system requirements, is the decoding performance of the received signal.

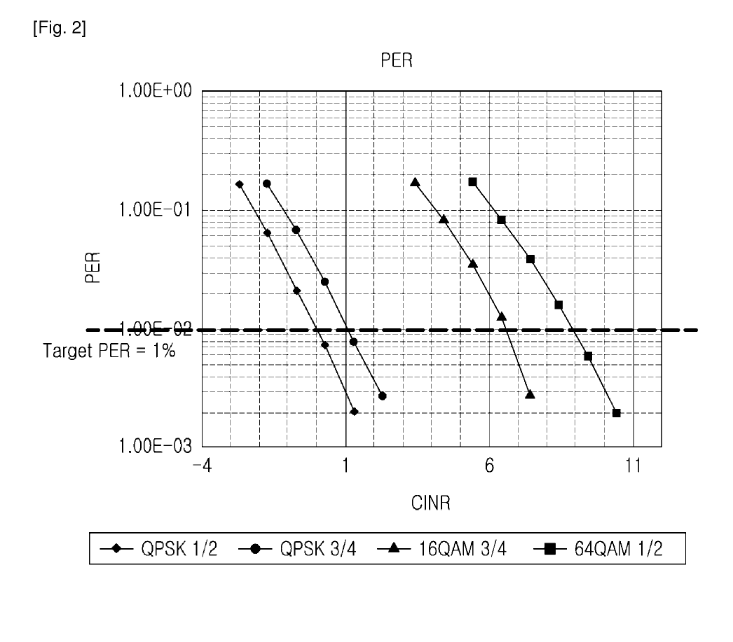

FIG. 2 is a diagram of performance of modulation schemes based on SNR in a wireless communication modem according to an exemplary embodiment of the present invention.

Referring to FIG. 2, the performance of the modulation schemes based on the Signal to Noise Ratio (SNR) of the wireless communication modem is illustrates. The modem is designed to transmit data using various modulation schemes according to the SNR of the terminal. Accordingly, in the high level design of the modem, it is designed to guarantee the decoding performance of the data transmitted using the highest modulation scheme.

For example, even when using 64QAM ½ of the worst performance in the number of bits of an Analog to Digital Converter (ADC) and the number of bits per block of each decoding channel, a system supporting up to 64QAM ½ is designed to satisfy the required performance.

The present invention regulates the number of the bits in each block along the decoding chain in accordance with the determined Carrier to Interference plus Noise Ratio (CINR) environment. In each block along the decoding chain, the power consumption is lowered by preventing the toggling of the related logic gates by outputting Least Significant Bits (LSBs) of data as zero not to impair the requirements in the decoding performance. Hereafter, this process will be referred to as requantization.

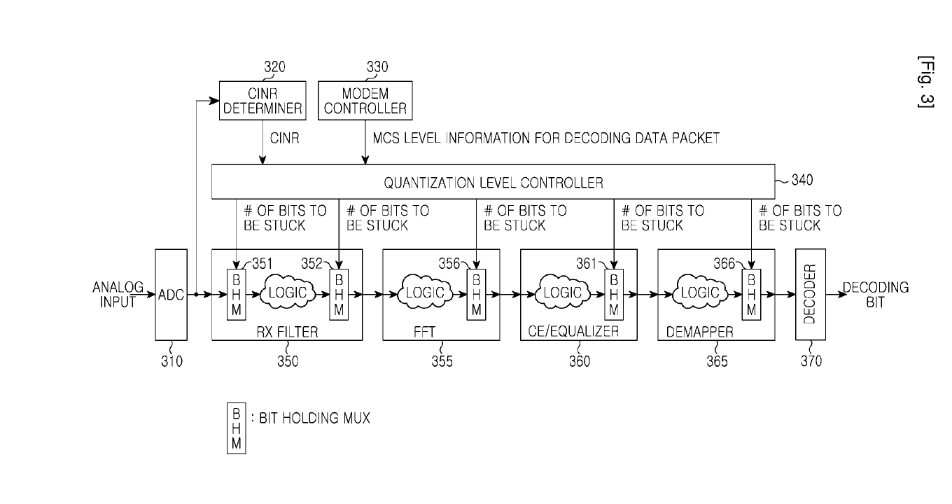

FIG. 3 is a block diagram of an apparatus according to an exemplary embodiment of the present invention.

Referring to FIG. 3, the apparatus suggested in the present invention includes a quantization level controller 340, a plurality of Bit Holding MUXs (BHMs) 351, 352, 356, 361 and 366, a CINR determiner 320, and a modem controller 330.

The quantization level controller 340 determines the number of bits to quantize per block of the decoding chain using modulation information of data to be decoded by the terminal as provided from the modem controller 330 and CINR information determined at the CINR determiner 320 of the terminal. The quantization level controller 340 provides the determined number of the bits to the BHMs 351, 352, 356, 361 and 366.

Herein, an Analog to Digital Converter (ADC) 310 converts an analog signal to a digital signal, and a decoder 370 decodes the input bits requantized.

The BHMs 351, 352, 356, 361 and 366 perform the requantization at output stages of the blocks 351, 355, 360 and 365 as many as the number of the bits provided from the quantization level controller 340.

Herein, the RX filter 350, the FFT 355, the equalizer 360, and the demapper 365 requantize the data or the signal to process as the number of the bits corresponding to the LSB to hold, using the BHMs 351, 352, 356, 361 and 366. The RX filter 350, the FFT 355, the equalizer 360, and the demapper 365 are referred to as a reception part.

The technique of the present invention operates in the SNR field exhibiting the better performance than the decoding performance required by the system, and reduces the power consumption by saturating at the decoding performance level required by this field.

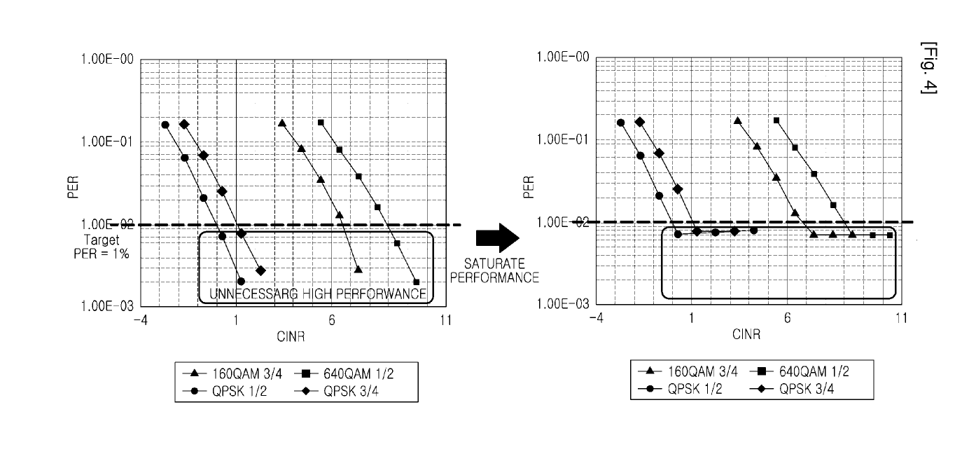

FIG. 4 is a diagram of PER when the performance saturation is applied according to an exemplary embodiment of the present invention.

Referring to FIG. 4, the requirement of the system is Packet Error Rate (PER)=1%. When the terminal is in the state higher than the SNR meeting the requirement, the toggling of the transistor is prevented by setting the LSBs of the data path to zero.

That is, when there is the unnecessary high performance as illustrated in the left graph, the toggling of the transistor is prevented by setting the LSBs of the data path to zero. In this case, the decoding performance always stays at 1%, be the external SNR ever so high as illustrated in the right graph.

By contrast, when the SNR currently determined by the terminal resides in the area not meeting the required SNR, the technique of the present invention is not applied.

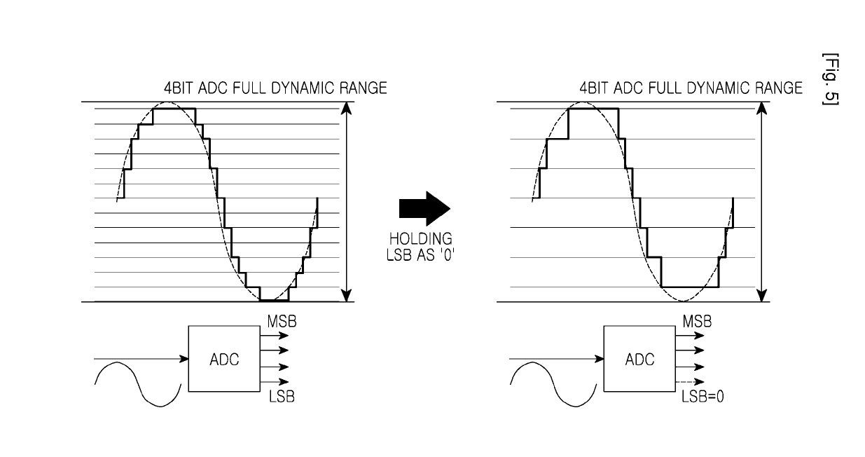

FIG. 5 is a conceptual diagram of variation of the quantization noise when the LSB of the digital signal is held to zero in the terminal according to an exemplary embodiment of the present invention.

Referring to FIG. 5, in the left graph, it is assumed that the CINR required for the terminal to decode its allocated data is 0 dB and the CINR actually determined by the CINR determiner of the terminal is 3 dB. The CINR determiner of the terminal determines the CINR always using every possible bit.

In this case, when the LSB 1 bit is set to zero as illustrated in the right graph, the quantization noise increases. As a result, the CINR applied to the actual decoding of the terminal is decreased to 1.5 dB due to the influence of the added quantization noise. However, 1.5 dB is still higher than 0 dB which is the required CINR of the terminal and thus satisfies the requirement. Herein, 1.5 dB is an experimental value.

That is, when the technique of the present invention is applied, the requirements can be satisfied and the power can be saved by reducing the toggling of the transistor.

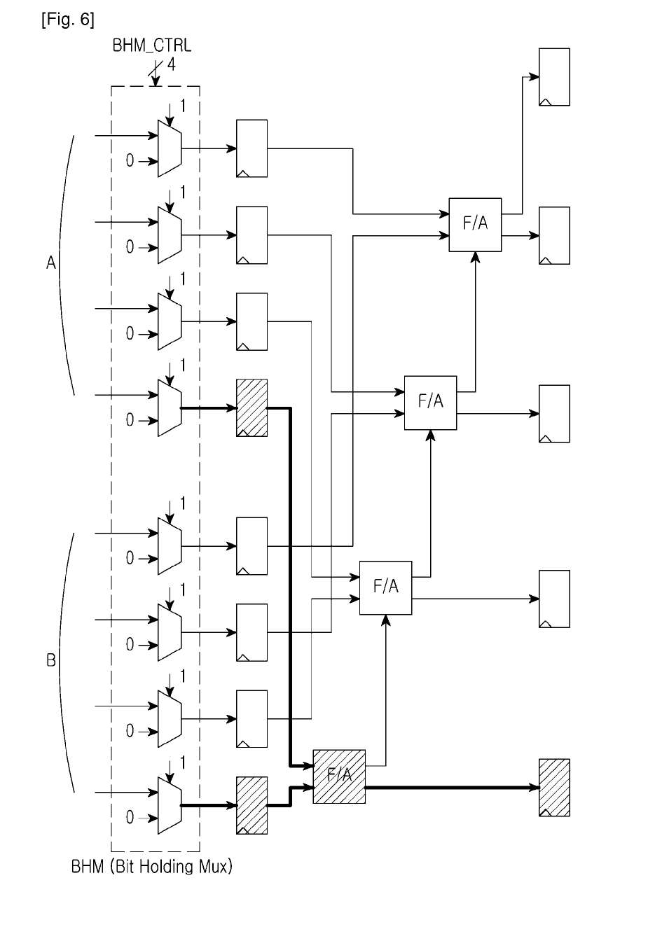

FIG. 6 illustrates a case where the technique of the present invention is applied to a simple 4-bit adder according to an exemplary embodiment of the present invention.

Referring to FIG. 6, when the LSB 1 bit of two input 4-bit signals a and b is held to zero, neither the resistor connected to the LSB or the combination logic circuit (the shaded part and the solid line) are toggled and both of the them are maintained as zero, thus not consuming the dynamic power. When the LSBs are held to zero, the power consumption decreases in proportion to the number of the held bits.

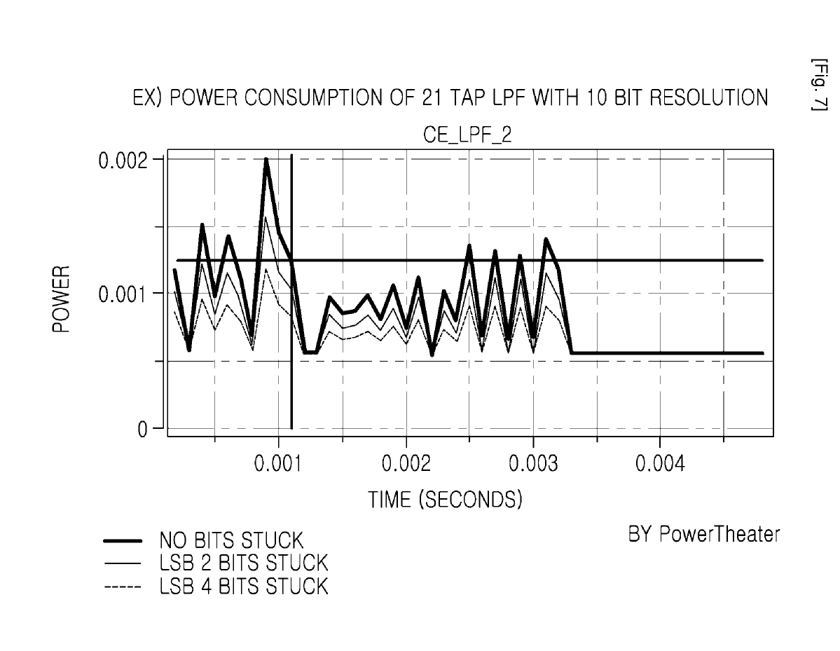

FIG. 7 illustrates the dynamic power consumption when LSB 2 bits and 4 bits of the input bits of an LPF are held to zero according to an exemplary embodiment of the present invention.

Referring to FIG. 7, when the LSB 2 bits and 4 bits of the bits input to the Low Pass Filter (LPF) are held to zero, the dynamic power consumption linearly lowers. That is, as the number of the held bits increases, the dynamic power consumption decreases.

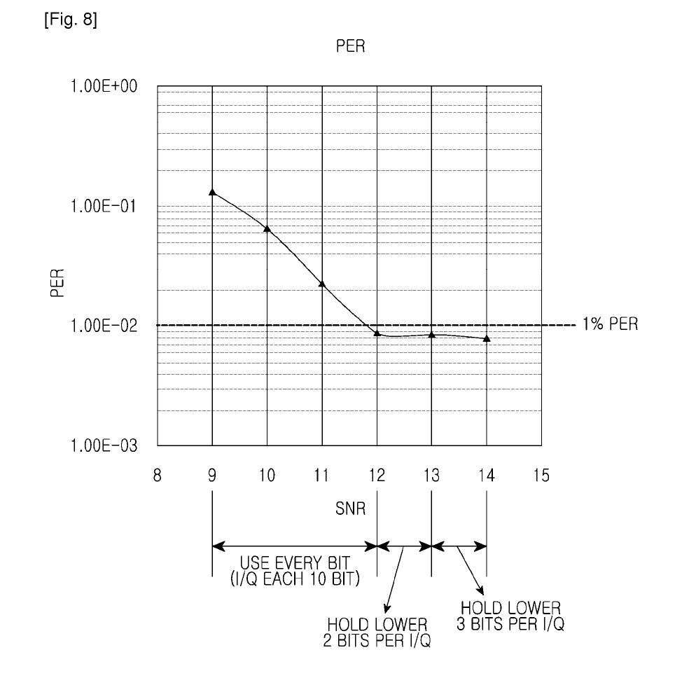

FIG. 8 is a diagram of the PER performance according to the bit holding according to an exemplary embodiment of the present invention.

In FIG. 8, the PER performance according to the bit holding of the LPF of FIG. 7 is illustrated. The communication standard is Mobile WiMAX, the radio channel is Vehicular A 60KM/H, and data is transmitted at the MCS level of 16QAM ½.

When the entire 10 bits are used, the SNR meeting the 1% PER is 12 dB. When a higher SNR is given, the decoding performing is maintained below 1% even though two or more LSB bits are held.

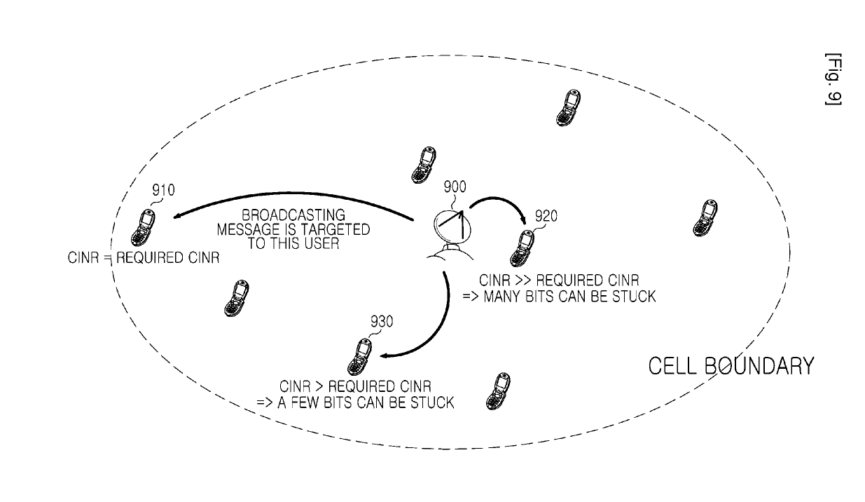

FIG. 9 illustrates an example of the broadcast message reception at the terminal according to an exemplary embodiment of the present invention.

Referring to FIG. 9, when receiving a broadcast message to be decoded by every terminal, a base station 900 transmits the message by regulating the signal strength such that even a terminal 910 traveling in its cell boundary under the worst environment can satisfy the required PER.

The terminals 920 and 930 close to the base station 900 have the CINR higher than the minimum CINR required to decode the broadcast message.

Hence, as increasing the quantization noise in the decoding chain using the technique of the present invention, those terminals 920 and 930 can lower the power consumption while meeting the PER performance.

At this time, the terminal can dynamically determine the number of the LSBs to hold to zero, based on the magnitude of the determined CINR. That is, as the CINR magnitude increases, the number of the LSBs to hold can increase. The number of the LSBs to hold based on the CINR magnitude can vary depending on the simulation, the experimental value in the actual implementation, the required service level, or the requirements of a provider.

Also, the number of the LSBs to hold based on the MCS level can vary depending on the simulation, the experimental value in the actual implementation, the required service level, or the requirements of the provider.

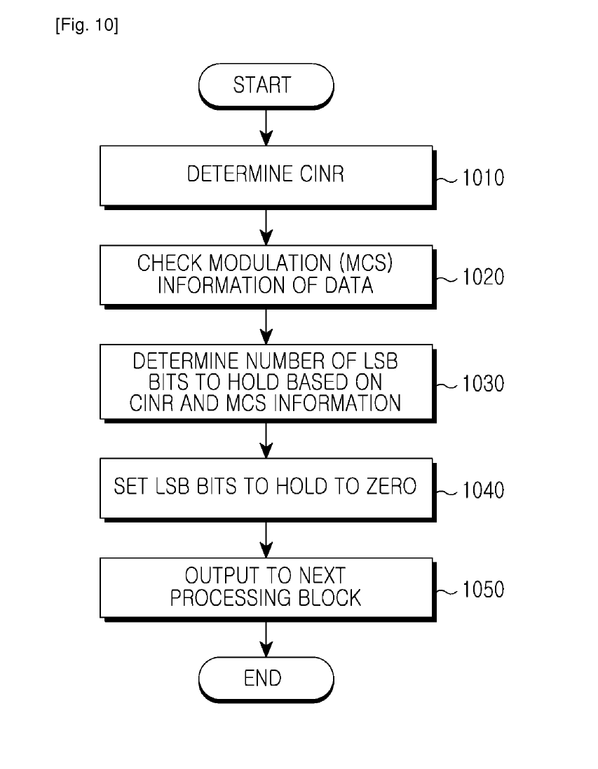

FIG. 10 is a flowchart of a method for saving power by holding the LSB to zero at the terminal according to an exemplary embodiment of the present invention.

Referring to FIG. 10, the terminal determines the CINR of the received signal in step 1010 and determines the MCS of the data in step 1020.

Next, the terminal determines the number of the LSBs to hold based on the CINR and the MCS information in step 1030. The terminal sets the LSBs to hold to zero in step 1040. Next, the terminal outputs the data with the LSBs held to zero to the next processing block in step 1050.

Next, the terminal finishes the algorithm of the present invention.

In the above process, particular blocks (FFT, equalizer, filter, demapper, etc.) can receive different control information from the quantization level controller, and the BHM of each particular block can hold the LSBs of the different numbers according to the control information.

The technique of the present invention can achieve the great power reduction and does not impair the requirements of the decoding performance of the system without additional considerable complexity. In addition, the present invention can be applied independent of the existing HDL level and the low power design schemes of the circuit level.

Fundamentally, when the terminal lies in the CINR area higher than the decoding performance required by the system, the present invention can save the power by lowering the power consumption instead of decreasing the unnecessarily high decoding performance. For doing so, the toggling of the internal signals is mitigated by holding the LSBs of the decoding chain to zero as much as the performance allowance.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for saving power at a receiver of a mobile communication system, the method comprising:
acquiring Carrier to Interference plus Noise Ratio (CINR) and Modulation and Coding Scheme (MCS) information required by the receiver;
determining the number of Least Significant Bits (LSBs) to hold based on the CINR and MCS information; and
holding LSBs of the determined number of the bits in received information.

2. The method of claim 1, further comprising:
outputting the information with the held LSBs to a decoder.

3. The method of claim 1, wherein the holding of the LSBs of the determined number of the bits in the received information comprises:
providing the LSBs of the determined number of the bits to an RX filter, a Fast Fourier Transform (FFT), an equalizer, and a demapper; and
requantizing, at the RX filter, the FFT, the equalizer, and the demapper, the received information as many as the number of the LSB bits to hold.

4. An apparatus of a receiver which saves power in a mobile communication system, the apparatus comprising:
a quantization level controller for acquiring CINR and MCS information required by the receiver and determining the number of LSBs to hold based on the CINR and MCS information; and
a reception part for holding LSBs of the determined number of the bits in received information.

5. The apparatus of claim 4, wherein the reception part outputs the information with the held LSBs to a decoder.

6. The apparatus of claim 4, wherein the reception part comprises:
an RX filter, an FFT, an equalizer, and a demapper for receiving the LSBs of the determined number of the bits and holding the LSBs of the determined number of the bits with respect to the received information by requantizing the received information as many as the number of the LSB bits to hold using an internal bit holding MUX.

7. A communication system for saving power in a mobile communication system, comprising:
a transmitter for transmitting information; and
a receiver for acquiring CINR and MCS information required by the receiver, determining the number of LSBs to hold based on the CINR and MCS information, and holding LSBs of the determined number of the bits in received information.

8. The communication system of claim 7, wherein the receiver comprises:
an RX filter, an FFT, an equalizer, and a demapper for receiving the LSBs of the determined number of the bits and holding the LSBs of the determined number of the bits with respect to the received information by requantizing the received information as many as the number of the LSB bits to hold using an internal bit holding MUX.
